(19) United States
(12) Patent Application Publication
(10) Pub. No.: US 2020/0134752 A1
(43) Pub. Date: Apr. 30, 2020

(54) House Hub

(71) Applicant: Cindy Ann Carey, San Jose, CA (US)

(72) Inventor: Cindy Ann Carey, San Jose, CA (US)

(21) Appl. No.: 16/170,167

(22) Filed: Oct. 25, 2018

(51) Int. Cl. G06Q 50/16; G06F 3/0484; G06Q 10/00

(52) U.S. Cl. CPC G06Q 50/163; G06Q 10/20; G06F 3/0484

(57) ABSTRACT

Disclosed method and system for providing maintenance services, the method comprising: receiving user credentials from at least one user; authenticating the at least one user based on the user credentials; receiving at least one item information related to property from the at least one user; generate at least one notification based on the at least one item information related to the property; and providing at least one service to the user based on the at least one item information related to the property.

### FIELD OF INVENTION

The inventive subject matter relates to home maintenance and more particularly to services related to home upgrades or home remodeling.

### BACKGROUND

In modern era all structures whether it is home, school, office or for any other purpose comprises concrete, iron, steel, wood, plastic and various other elements. These structures include various appliances and equipment such as gas, refrigerator, and furniture and so on. All the elements and equipment have certain life span and beyond that they may or may not start malfunctioning. To avoid such problems, arising due to malfunctioning of building materials or some damage caused by the various structural elements, maintenance of these buildings and equipment is the prerequisite for safety of society. At the time of construction, for few years, construction companies give the free repair and maintenance services to a house owner (say), but after that stipulated time period it becomes the sole responsibility of the owner to take care of each and everything. In today's era not all the individuals having that much time to analyze and repair their malfunctioning equipment or co-ordinate with each and every expert belonging to different domains such as carpenter or plumber. A user needs an integrated system or a method where he can find one stop solution for the complete maintenance of his house. The system or method should be able to provide high quality services at fair prices. The system or method should be able to calculate an estimated cost and predict estimated next maintenance cycle.

There is a lack such a large scale system that is able to manage a large customer database. In a house the number of appliances and equipment were installed and the user does not other about to catalog all the information related to the components installed in the house. In this case it becomes difficult to keep a track on the maintenance of these components. The user is also not able to keep a track on life span of all the components. With the increase in digital technology and increasing amount of data related to a plurality of factors, with the propagation of internet of things (IOT), and many other factors, a need exists for an automated system that will enable improved outcome for consumers and provide home maintenance and repair services.

There should be a system or method that should be capable of providing an integrated user interface to consumers for home maintenance and repair related services. The inventive subject matter provides a solution to the drawbacks or problems faced related to home maintenance and repair without overloading and restrictions.

### SUMMARY OF THE INVENTION

The inventive subject matter discloses a system to provide maintenance services, comprises: a storage device to store a plurality of user credentials; and a central processing unit (CPU) configured to: receive first user credentials, via a user interface, from at least one user; compare the first user credentials with at least one second user credentials of the plurality of user credentials stored in the storage device to authenticate the first user; receive, via the user interface, at least one item information related to a property from the first user and store the received at least one item information in the storage device; generate at least one notification based on maintenance database, wherein the maintenance database comprises the first user-defined start time/end time associated with the at least one item information and product warranty information, provided by the first user; and transmit, via a transmission path, the generated at least one notification to the first user device, wherein the generated notification is displayed on a display unit of the first user device.

The inventive subject matter further discloses a method for providing maintenance services, the method comprising: receiving, via a user interface, a first user credentials from at least one user; comparing the first user credentials with at least one second user credentials of the plurality of user credentials stored in a storage device to authenticate the first user; receiving, via the user interface, at least one item information related to a property from the first user; and storing the received at least one item information in the storage device; generating at least one notification based on maintenance database, wherein the maintenance database comprises the first user-defined start time/end time associated with the at least one item information and product warranty information, provided by the first user; and transmitting, via a transmission path, the generated at least one notification to the first user device, wherein the generated notification is displayed on a display unit of the first user device.

The inventive subject matter further discloses a non-transitory computer-readable medium to store computer-executable instructions, executed by a processor, cause a computer to perform maintenance services, the method comprising: receiving, via a user interface, a first user credentials from at least one user; comparing the first user credentials with at least one second user credentials of the plurality of user credentials stored in a storage device to authenticate the first user; receiving, via the user interface, at least one item information related to a property from the first user; and storing the received at least one item information in the storage device; generating at least one notification based on maintenance database, wherein the maintenance database comprises the first user-defined start time/end time associated with the at least one item information and product warranty information, provided by the first user; and transmitting, via a transmission path, the generated at least one notification to the first user device, wherein the generated notification is displayed on a display unit of the first user device.

The inventive subject matter further discloses the system, wherein at least one sensor and at least one timer coupled with at least one item related to the property, and wherein the at least one sensor and the timer transmits sensor data and usage history of the at least one item related to the property to the storage device.

The inventive subject matter further discloses the system, wherein the CPU is further configured to determine a usage-time of the at least one item related to the property based on the usage history received from the timer and determine at least one parameter based on reception of the sensor data.

The inventive subject matter further discloses the system, wherein the CPU is further configured to generate the at least one notification based on the determined usage-time or the determined parameters.

The inventive subject matter further discloses the system, wherein the at least one parameter comprises temperature, humidity, current rating of the at least one item related to the property.

The inventive subject matter further discloses the system, wherein the CPU is further configured to provide at least one service to the first user based on reception of a service request from the first user device.

The inventive subject matter further discloses the system, wherein the CPU is further configured to provide a list of service providers, for at least one service, to the first user device based on reception of a service request from the first user device.

The inventive subject matter further discloses the system, wherein the first user selects at least one service provider out of the list of service providers.

The inventive subject matter further discloses the system, wherein the CPU is further configured to set-up a communication link between the selected at least one service provider and the first user.

The inventive subject matter further discloses the system, wherein the first user credentials selected from one of the following: at least one of registered username, face recognition, voice command, biometric information, a one-time password (OTP), and payment information.

The inventive subject matter further discloses the system, wherein the at least one item information related to the property is associated with at least one of area of house, furniture, at least one image of a portion of house, roof, floor, door, cabinet, home alarm system, water heater, solar panel, smoke detector, elevator, plumbing system or devices, electrical system or devices, lighting system or devices, CCTV or video surveillance camera.

The inventive subject matter further discloses the system, wherein the at least one service comprises home maintenance, home upgrade, home remodeling, or new home construction.

The inventive subject matter further discloses the system, wherein the at least one notification selected from one of the following: a text message, an email, and a phone call.

The inventive subject matter further discloses the system, wherein the at least one service is provided to the first user based on the first user-initiated request.

The inventive subject matter further discloses a method for providing maintenance services, the method comprising the steps of receiving user credentials from at least one user; authenticating the at least one user based on the user credentials; receiving at least one item information related to property from the at least one user; generate at least one notification based on the at least one item information related to the property; and providing at least one service to the user based on the at least one item information related to the property.

The inventive subject matter further discloses the user credentials comprises at least one of registered username, face recognition, voice command, biometric information, a one-time password (OTP), or payment information.

The inventive subject matter further discloses the authentication process involves a comparison of the user credentials with historical information stored in a memory.

The inventive subject matter further discloses the at least one item information related to the property is associated with at least one of area of house, furniture, at least one image of a portion of house, roof, floor, door, cabinet, home alarm system, water heater, solar panel, smoke detector, elevator, plumbing system, electrical system, lighting system, CCTV or video surveillance camera, time-related information, and wherein the time-related information is associated with the at least one item information related to the property.

The inventive subject matter further discloses the at least one service comprises home maintenance, home upgrade, home remodeling, or new home construction.

The inventive subject matter further discloses the home maintenance includes management of at least one home system, at least one product.

The inventive subject matter further comprises tracking the at least one item information related to the property provided by the at least one user.

The inventive subject matter further discloses the at least one service comprises at least one of maintenance, repair, cleaning, restoration, painting, or renovation.

The inventive subject matter further discloses the at least one notification comprises a text message, an email, or a phone call.

The inventive subject matter further discloses the at least one service is provided to the user based on a user-generated request.

The inventive subject matter further discloses the at least one notification is generated based on the time-related information, and wherein the time-related information is calculated based on the received at least one item information related to the property.

The inventive subject matter further discloses an estimated cost for the at least one service is calculated based on the at least one item information related to the property.

The inventive subject matter further discloses the electronic device is at least one of a cellular phone, a tablet, a personal computer, a desktop or combination thereof.

The inventive subject matter further discloses the user interface displays a plurality of menu buttons based on the at least one item information related to the property.

The inventive subject matter further discloses the user interface displays a real-time status of the at least one item information related to the property on the electronic device.

The inventive subject matter further discloses the CCTV or video surveillance camera is configured to: capture image of the at least one item information related to the property at a regular interval of time; and transmit the captured image to a server.

The inventive subject matter further discloses the server compares the captured image with historical information and generates alert notifications based on the comparison.

The inventive subject matter further discloses the at least one service comprises multi-level maintenance service, modular maintenance service, predictive service, preventive service, shut down service, controlling service.

The inventive subject matter further discloses a plurality of sensor data is transmitted to a server in real-time, wherein the sensor data includes the at least one item information related to the property, and wherein the server generates a notification based on the sensor data.

In one another objective of the inventive subject matter the user credentials comprise at least one of registered username, face recognition, voice command, biometric information, a one-time password (OTP), payment information, and any password.

In one another objective of the inventive subject matter the authentication process involves a comparison of the user credentials with historical information stored in a memory.

In one another objective of the inventive subject matter the at least one service comprises home maintenance, home upgrade, home remodeling, or new home construction.

In one another objective of the inventive subject matter the home maintenance includes management of at least one home system, at least one product.

In one another objective of the inventive subject matter comprises tracking the at least one item information related to the property provided by the at least one user.

In one another objective of the inventive subject matter the at least one service comprises at least one of maintenance, repair, cleaning, restoration, painting, or renovation.

In one another objective of the inventive subject matter the at least one notification comprises a text message, an email, or a phone call.

In one another objective of the inventive subject matter the at least one service is provided to the user based on a user-generated request.

In one another objective of the inventive subject matter the at least one notification is generated based on the time-related information, and the time-related information is calculated based on the received at least one item information related to the property.

In one another objective of the inventive subject matter, an estimated cost for the at least one service is calculated based on the at least one item information related to the property.

In one another objective of the inventive subject matter the electronic device is at least one of a cellular phone, a tablet, a personal computer, a desktop or combination thereof.

In one another objective of the inventive subject matter the user interface displays a plurality of menu buttons based on the at least one item information related to the property.

In one another objective of the inventive subject matter the user interface displays a real-time status of the at least one item information related to the property on the electronic device.

In one another objective of the inventive subject matter the CCTV or video surveillance camera is configured to: capture image of the at least one item information related to the property at a regular interval of time; and transmit the captured image to a server.

In one another objective of the inventive subject matter the server compares the captured image with historical information and generates alert notifications based on the comparison.

In one another objective of the inventive subject matter the at least one service comprises multi-level maintenance service, modular maintenance service, predictive service, preventive service, shut down service, controlling service.

In one another objective of the inventive subject matter a plurality of sensor data is transmitted to a server in real-time, wherein the sensor data includes the at least one item information related to the property, and wherein the server generates a notification based on the sensor data.

In one another objective of the inventive subject matter based on the image processing the real-time status of the at least one item information related to the property is accessible and this information is compared with the historical information. The historical information is the information submitted or information captured at the time of the registration process. This comparison results in the actual status of the property and based on a mathematical modal the next maintenance cycle is calculated. This technique also calculates estimated cost for the maintenance and repair of the house based on the status of the parameters.

In one another objective of the inventive subject matter a server is connected to a plurality of sensors. The server generates an alert notification in an event a value of at least one sensor exceeds a threshold value. This alert notification helps in enhancing safety as well as the security of the house.

In one another objective of the inventive subject matter the notification received by the user and based on the received notification the user requests for a particular service. This server receives user request and contacts a service provider. The user is provided with the historical information, profile information and contact information related to a particular service provider.

In accordance with these objectives of the inventive subject matter, it is understood that the inventive subject matter overcomes the drawbacks of the conventional techniques and provides an improvement over these conventional techniques.

### BRIEF DESCRIPTION OF THE DRAWINGS

For a more complete understanding of the inventive subject matter, reference is now made to the following description taken in conjunction with the accompanying drawings, in which:

FIG. 1 is a block diagram of the house-hub system.

FIG. 2A is a schematic representation of the user interface in one embodiment.

FIG. 2B is a schematic representation of the user interface according to a second embodiment.

FIG. 3 is a flowchart representing the steps of automatic maintenance services.

FIG. 4 is a system representation of a general purpose computer related configuration.

FIG. 5A is a flowchart disclosing the steps from registration to alert notifications generation.

FIG. 5B is a continuation of the flowchart disclosed in FIG. 5A.

FIG. 5C is a continuation of the flowchart disclosed in FIG. 5A.

FIG. 6 is a representation of graphical user interface (GUI) of the system.

FIG. 7 is a representation of the GUI for insertion of the property details.

FIG. 8 is a representation for uploading property related documents via GUI.

FIG. 9 is a list of glossary of building terms.

FIG. 10 is a representation of editing property details in continuation of FIG. 7.

FIG. 11 is another representation of editing property details in continuation of FIG. 7.

FIG. 12 is another representation of editing property details in continuation of FIG. 7.

FIG. 13 is another representation of editing property details and manual comments.

FIG. 14 is a representation of adding property details and receiving confirmation from the server.

FIG. 15 is a representation on GUI that shows added property details and maintenance information.

FIG. 16 is another representation of maintenance information in continuation of FIG. 15.

FIG. 17 is another representation of maintenance information in continuation of FIG. 15.

### DETAILED DESCRIPTION OF THE INVENTION

Embodiments of the present disclosure will be described more fully hereinafter with reference to the accompanying drawings and in which example embodiments are shown. Embodiments of the claims may, however, be embodied in many different forms and should not be construed as limited to the embodiments set forth herein. The examples set forth herein are non-limiting examples and are merely examples among other possible examples. The invention can be better understood with the help of a detailed description of the drawings and preferred embodiments of the invention.

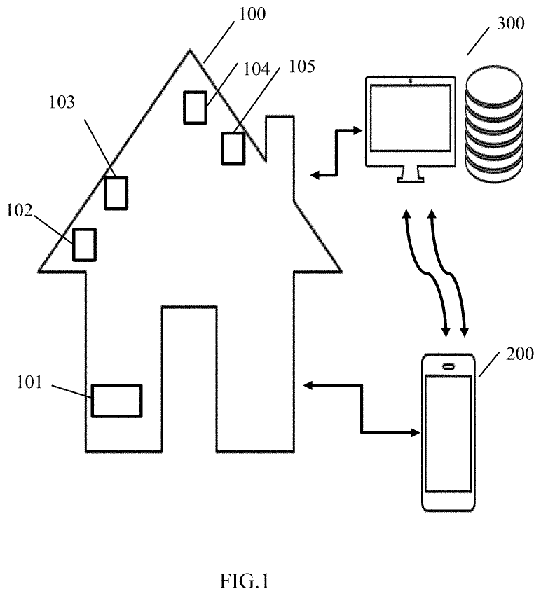

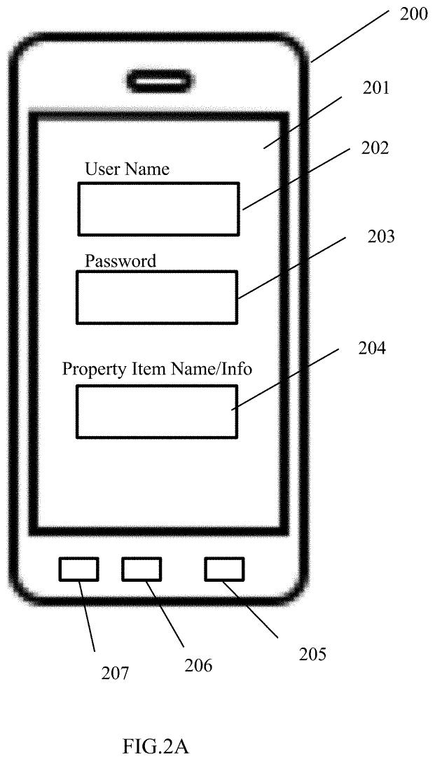

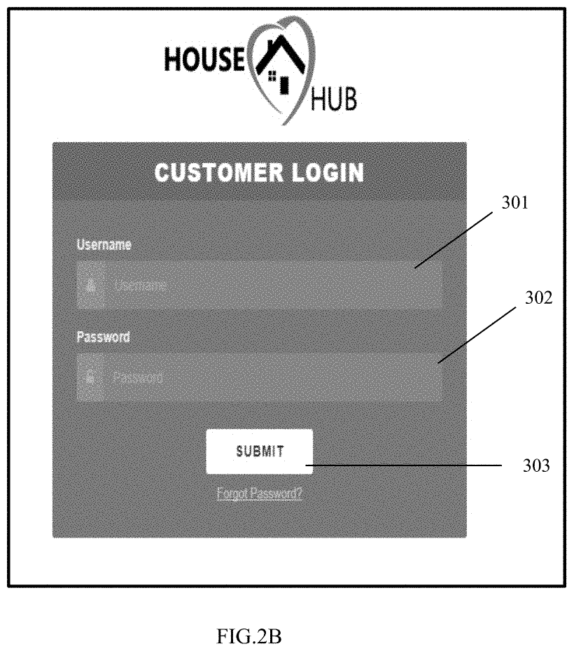

Referring to FIG. 1 discloses a block diagram of the house-hub system. The system comprises a house 100, a communication terminal 200, and a server 300. The house 100 includes a number of items or household equipment such as furniture 101, plumbing equipment 102, at least one sensor 103, electrical bulb 104, and water heater 105. The number of items in a particular house is not limited to these only and can include any number of items. The communication terminal or user communication device 200 is an electronic device that is communicatively coupled with the items of the house and with the server 300. The detailed description of communication terminal 200 will be described in FIGS. 2A and 2B. The server 300 is coupled with both the items of the house and with the communication terminal 200. The server 300 stores all the information related to the sensor data and user-provided information in the database (not shown).

Referring to FIG. 2A illustrates a representation of the user interface of the communication terminal 200. The communication terminal 200 is selected from a mobile device, a cellular phone, tablet, personal computer (PC), pager, but not limited to these only. The communication terminal 200 or user communication device 200 comprises a user interface 201 that displays a plurality of menu-based options to the user. The user initiates the registration process by inputting user credentials in user interface 202, password provided to the user in user interface 203. Once the registration process is completed successfully the user s directed to a second user interface 207 either on the same page or on a second page. The user is provided with a plurality of property related options. The user provides the information, via user interface 207, related to the plurality of items included in the property.

The communication device or user communication device 200 is provided with control buttons 206, 206, and 207. These control buttons 205-207 provides the user to shift from a first page to a second page to select a plurality of options related to providing property related information. The user is prompted to save all the information provided via the user interface on the communication terminal 200. The user is authorized to update the provided information any time. In this manner, the information related to all the items in a particular house are logged and analyzed for generation of alert notifications related to maintenance and repair.

Referring to FIG. 2B illustrates the graphical user interface (GUI) in the second embodiment. A first button 301 receives the username, a second button 302 receives a password and a third button 303 provides a submit button to log in successfully into the system. After logging into the system the GUI displays a number of properties related information to the user, to be filled by the user.

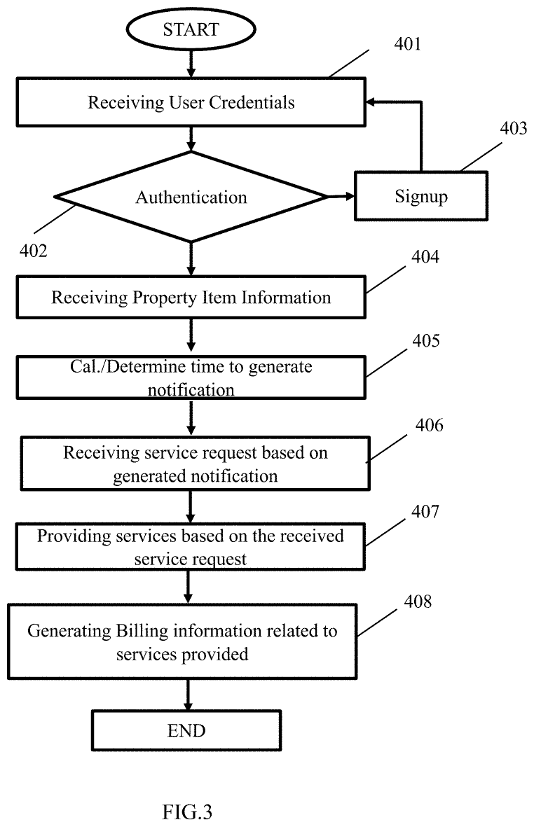

Referring to FIG. 3 discloses a flowchart representing various steps of automatic maintenance services. In this flowchart, at step 401, a user interface receives user credentials such as name, age, sex, password, unique identification (ID) number. The user credentials are not related to these only and any user-related information can be used as user credentials. At step 402, a processor (not shown) in the system compares user-provided credentials to a second information stored in the database. In a case, wherein the user credentials did not match with the stored information, the user is directed to either a signup process, at step 403, to register the user as a new user or to generate a new password if the user is already a registered user.

The user is provided with the user interface on the display device at step 404, to receive information related to items of property. The user can provide property related information for each and every component installed in the house. This information includes, but not limited to, area of house, furniture, at least one image of a portion of house, roof, floor, door, cabinet, home alarm system, water heater, solar panel, smoke detector, elevator, plumbing system, electrical system, lighting system, roof material, at least one kitchen appliance, tile types, CCTV or video surveillance camera, and time-related information. At step 405, the system calculates a time period based on the information provided.

This time period is calculated to generate alert notifications for the user, to maintain safe conditions of the house. The time can be calculated from at least one of the sensor provided data, user-defined, image processing of the information, or the real-time condition of equipment. A plurality of sensors are coupled with the at least one item related to the property. The plurality of sensors communicates with the server 300 and provides real-time information related to the at least one item of the property and in response to the received information, the server 300 calculates the usage time for the at least one item related to the property.

The sensor data can be categorized into three categories such as moderate, average, and critical and based on the comparison of the sensor data with a threshold defined for each level, the system generates notifications and those generated notifications are received on the user device. The user, in response to the received notification requests for a service request. The server 300 provides a list of service providers in response to the service request and sets up a communication link between the user and the at least one service provider. The at least one processor is configured to generate at least one notification when at least one of a moisture level or humidity level for at least one item related to the property becomes more than a threshold value and in response, the user receives the notification. In response to the received notification, the user initiates a request for maintenance via the graphical user interface.

The system also generates notifications based on a user-defined maintenance database and transmits the generated notifications to the communication terminal. The maintenance database stores manual notification timelines and the at least one item specific timelines. The manual notification timelines are start time/end time defined by the user in the maintenance database. The item specific timelines include the warranty card or warranty/maintenance related information provided or specified by each of the at least one item related to the property. The generated notifications also include options for a service request to be selected by the user.

At step 406, the interested users selected the service requests and the responses are received by the system. The system, at step 407, communicates with at least one service provider, registered with the system. The selected service provider is communicated with the address and contact details of the user. The user is provided with the billing information along with the details of the service provider at step 408. In a case, the user makes the payment for the services the process proceeds further and after completion of the process the user is provided with a feedback option. In this manner, house maintenance related services can be provided through a centralized system and by a user of the communication terminal.

Any number of users can register for any number of property items by making the payment via a payment gateway such as PayPal (a registered Trademark), for a specific time period. The user device generates a request message to be transmitted to the at least one service provider. The at least one service provider generates a bid work based on a user input. The user. The user approves the work based on the received bidding amount.

Users via user communication device 200 can renew their services any time by making the renew amount through a number of payment gateways and updating their user credentials. The user is performing all function or activity via user communication device 200 by accessing the user interface.

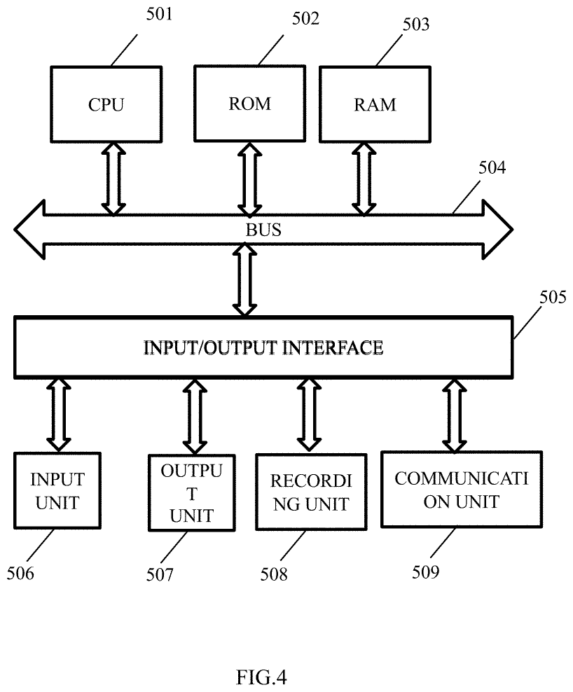

Referring to FIG. 4 discloses a system representation of a general-purpose computer configuration. The above-mentioned process can be accomplished with the help of a central processing unit (CPU) 501, read-only memory (ROM) 502, Random access memory (RAM) 503, a bus 504, an input/output interface 505, an input unit 506, output unit 507, a recording unit 508, a communication unit 509. The system of all these components is communicatively coupled with each other via the bus interface 504. The above-mentioned process of automated house maintenance services can be realized based on the above-mentioned system.

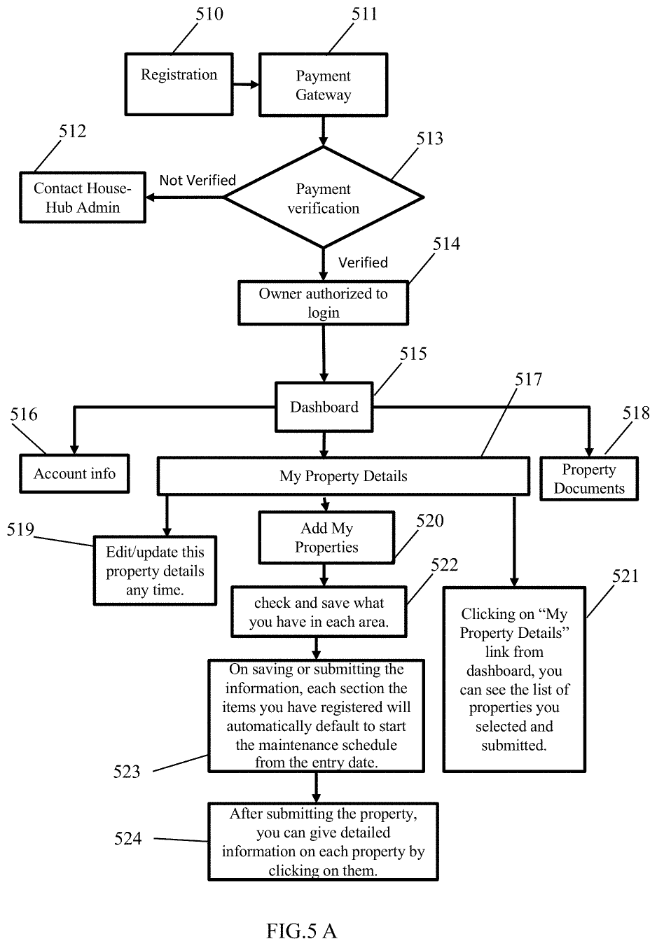

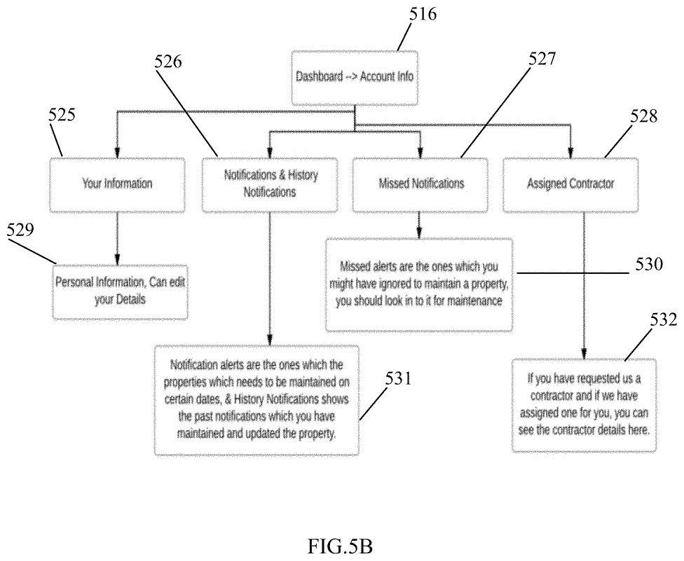

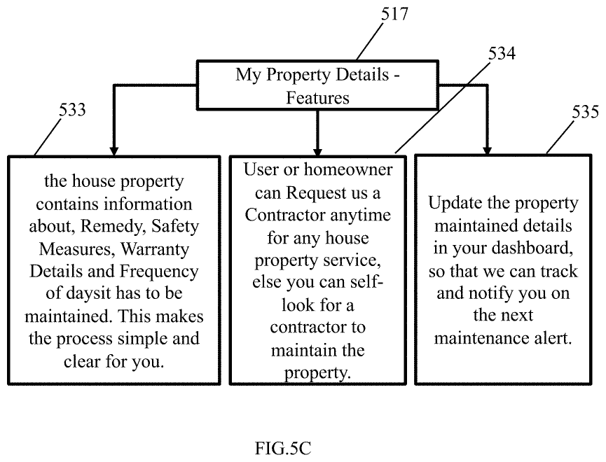

Referring to FIG. 5A discloses a flowchart disclosing the steps from registration to alert notifications generation. The homeowner completes registration based on an input on a registration button 510 during a registration process. The user process is completed based on providing user credentials along with successful payment verification through a payment gateway 511. At least one processor is configured to verify the payment received at payment verification step 513. In case the payment is not verified a notification disclosing control house-hub admin 512 is displayed on a graphical user interface. After verification of the payment verification process 513, the user is authorized to log in 514 via the login button. After login into the system, a dashboard 515 is displayed to the user. The user is able to provide input to the GUI (Graphical User interface) or user interface via at least one of account information 516, property details 517, and upload property documents 518. The details of account information 516 and property details 517 are described in the subsequent FIGS. 5B and 5C.

The user can edit or update the property details via the control button 519 at any time and based on the user input on the property details 517, the user is able to view the list of properties selected and submitted. Next, to the property details, a radio button 520 enables to add information related to the property. After clicking on radio button 517, the list of properties the user has selected and submitted are displayed under the title of “My Property Details” in the form of a notification 521. To further process “My Property Details” the user is provided with a check and save button to save the provided information via a button 522. After completion of the saving, the system starts calculating the time for maintenance from the entry date and shown on the GUI (Graphical User interface) as a notification as 523 in the form of an icon. After submitting the property details the user can provide detailed information on each property based on the input from the control button 524.

Referring to FIG. 5B represents the detailed description about the account information 516. The account information includes user information 525, notification and history information 526, missed notification 527, and assigned contractor 528 for the maintenance of the property. The user information 525 includes but not limited to personal information 529 and this personal information is editable by the user at any time period. The notification and history information includes notification alerts 531. These notification alerts include the alerts regarding the property needs to be maintained on certain dates or after certain time periods from their installation and the past maintenance information if any. The missed notification 527 includes missed alerts 530 to maintain property which are missed or ignored by the user. The assigned contractor 528 includes at least one contractor or a list of contractors and the user is able to extract the contractor details from the assigned contractor icon 532.

Referring to FIG. 5C the detailed description of the property details 571 are shown. The “my property details” includes house property 533 that includes information related to remedy, safety measures, warranty details, and the frequency of days. The second property details feature button named as a request for a contractor 534. This helps the user in finding a contractor based on his requirements and the control button 535 includes update property in the dashboard and the at least one processor is configured to track and notify the user about the maintenance alerts and in addition the importance of maintenance related articles or suggestions.

The homeowner receives alert notifications related to maintenance and repair for a particular period of time. After the expiration of that particular period of time, the user can again enroll for the home maintenance services. The homeowner will be authorized to login in the system via a dashboard page on the user interface. The user will receive all the property, maintenance, and notification alerts information based on the registration process and the property related information. The property details pages are provided to the homeowner to enter the at least one item information related to the property.

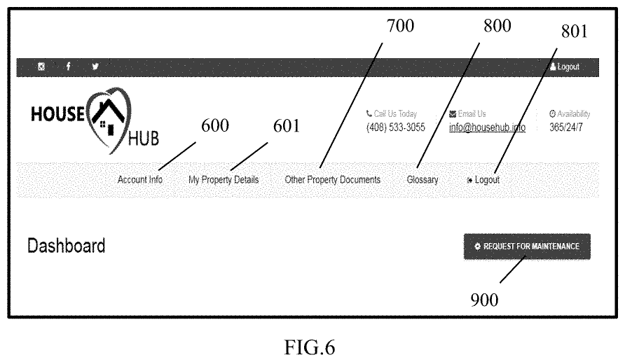

Referring to FIG. 6 represents the GUI of the system providing various menu options starting from such as account information 600, My property details 601, other property documents 700, glossary items 800, log out from the system button 801, and request for maintenance button 900. The user is facilitated with all these menu buttons from 600 to 900 to provide add and upload property-related information on the server 300 and save it. The user can request for maintenance related services any time by clicking on the request for maintenance button 900. The details of other menu options disclosed herein will be described in detail in subsequent figures.

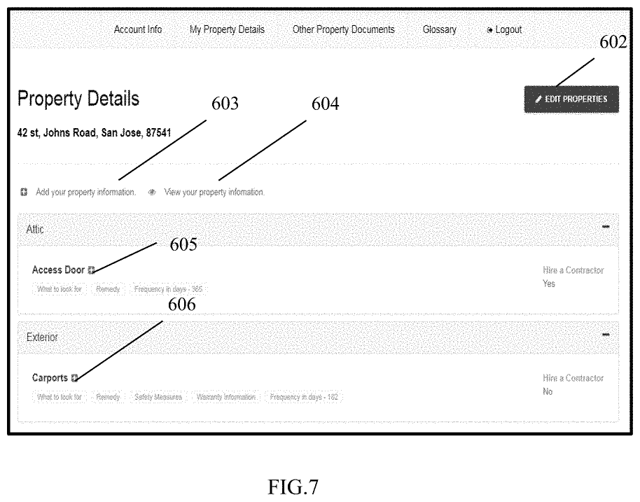

Referring to FIG. 7 represents the GUI for providing the property details. The user is directed to a next GUI, by at least one processor, after providing an input on my property details 601. The user in FIG. 7 is provided with a plurality of options related to the property details. The user can edit property details by entering into a menu of edit property via edit properties button 602. In the property details a plurality of options such as add property options 603, view property information 604, property access door 605, and carports 606 are shown. The access door 605 and carports 606 are shown already added to the property details for explaining the process flow only. The detailed description of property information 604 and property options 603 will be described in subsequent figures.

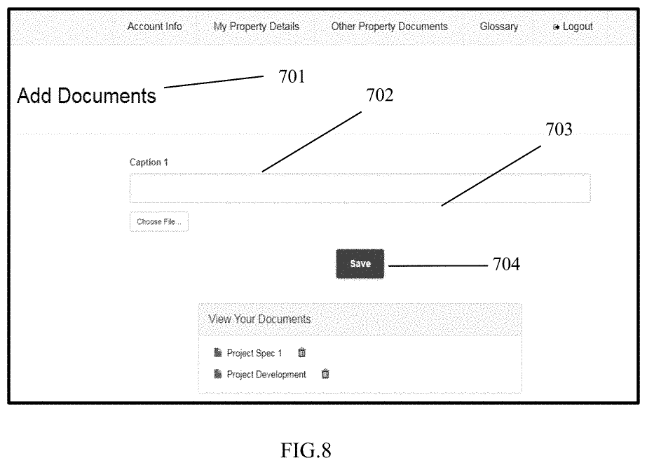

Referring to FIG. 8 represents a user interface for uploading property related documents via GUI (Graphical User interface). The user is directed to this add documents GUI based on a user input on the other property documents 700 as shown in FIG. 6. The user is provided with at least one option based on an input on the add documents 701. The user input results in an option 702 on the GUI (Graphical User interface) that allows the user to upload a property related documents. A file selector button 703 is provided to select a file to be uploaded. The number of file formats including jpeg, bitmap, pdf, doc supported by the file formats are not limited to the above-mentioned formats only. The next step, after uploading at least one property related document is to save by allowing a user to provide a save command via a save button 704. After saving the uploaded documents the user can view the uploaded documents on the same GUI (Graphical User interface).

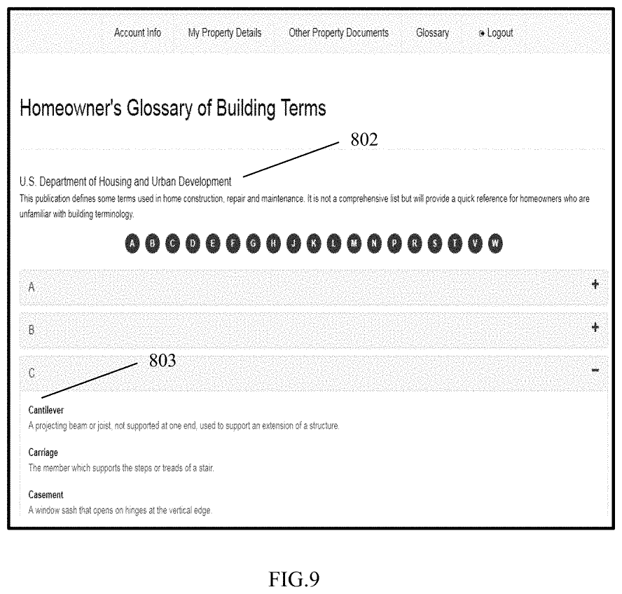

Referring to FIG. 9 represents a list of glossary of building-related terms. The user is directed to the glossary page based on the user input on the glossary 800 as shown in FIG. 6. A button of homeowner's glossary of building terms 802 is provided on the GUI. This glossary of building terms is provided to the users to have completed in-depth knowledge of their property. The input to the glossary of building terms 801 displays a certificate of authorization 802, and a list of definitions 803 along with their details. The user can fetch this glossary of building terms anytime for their reference. This system updates the number of definition of the glossary terms and their types with the passage of time.

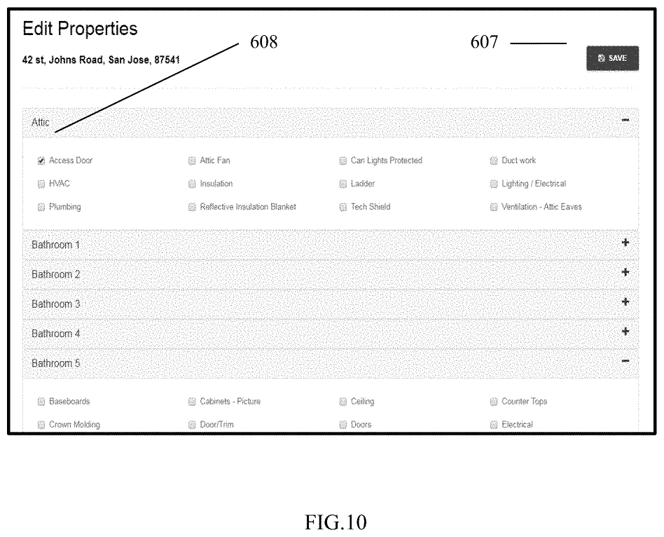

Referring to FIG. 10 in continuation of FIG. 7 represents a plurality of editing options related to the property. The at least one processor directs the user control to edit properties based on the user input. In this GUI (Graphical User interface) the user is provided with a number of predefined options that the user has to select. The user is provided with, for example, attic 608, bathroom, room, kitchen, store, and stairs but not limited to these options only. The at least one processor displays a number of options based on reception of a user input on the attic 608. The user is provided with at least, for example, access door, Heating, ventilation, and air conditioning (HVAC), reflection insulation blanket, ladder, lights protecting, tech shield, ductwork, lighting, electrical, ventilation, attic fan. The menu options are not limited to the above-mentioned options only and the user can provide a manual entry for a particular type attic in this section. After entering all the details in the GUI the user is directed to save the details based on an input on a save button 607.

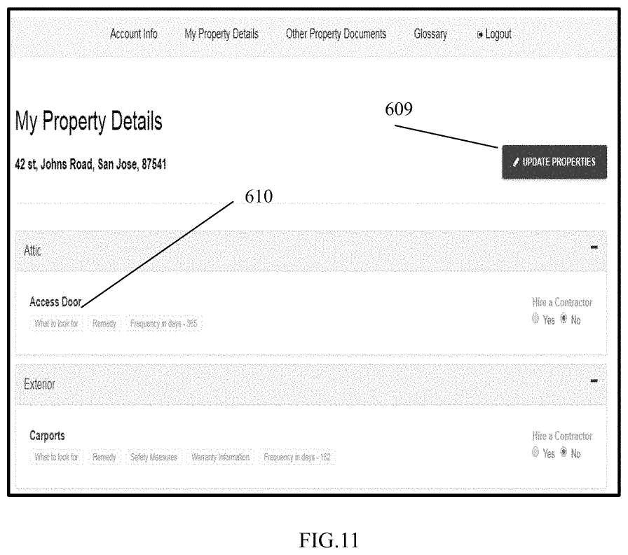

Referring to FIG. 11 represents various options related to editing property details in continuation of FIG. 7. As describes above the user is either directed to select a property item from the menu or the user can provide a manual entry and save that manual entry. The user is provided with update properties 609 buttons on the FIG. 11. This button facilitates the user to update the selected property details that were saved earlier. Based on the user input on the update properties 609, the user is provided with my property details where the at least one processor displays the saved property details which are saved by the user. The user provides an input on the access door 610 to update the details for example. On a ride side of the access door 610, the processor displays options to hire a contractor for maintenance. By default, the voting buttons to hire the contractor are set to NO. In a similar manner, as for the access door 610, the user is provided with a plurality of options to update their property details.

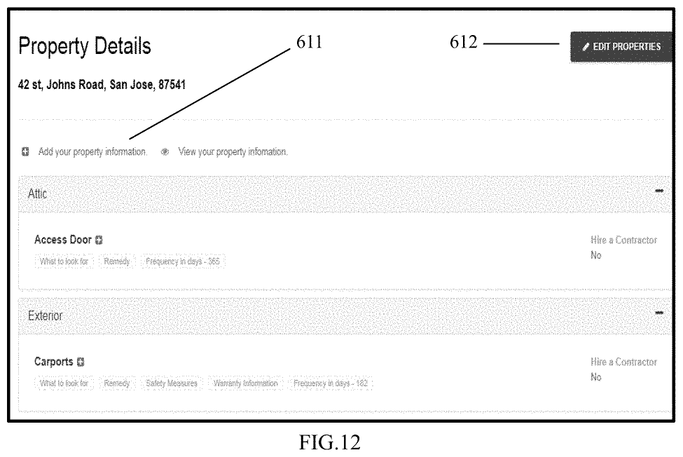

Referring to FIG. 12 represents GUI (Graphical User interface) related to editing property details in continuation of FIG. 7. In this FIG. 12, the user is provided with two control button such as edit property details 612 and adds property information 611. The add property information 611 a list of property related items classified in a database such as in a category of attic it is displaying access door and in the second category of the exterior the system shows carports. The user can select one out of two options to hire a contractor. The user can review their input at any instant of time.

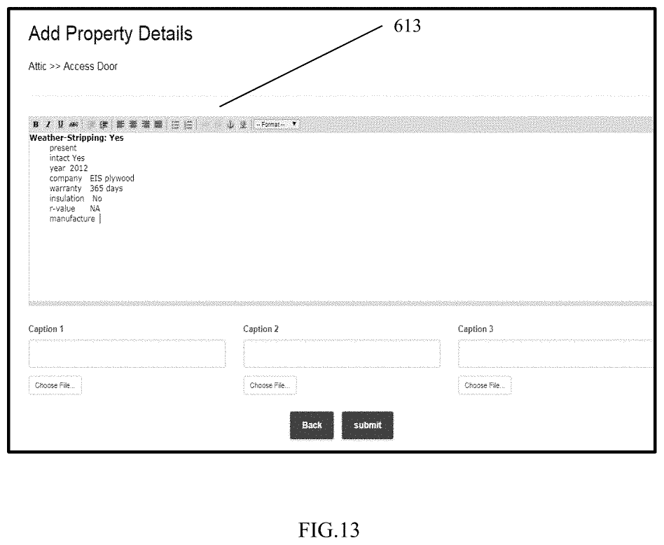

Referring to FIG. 13 is another representation of manually adding property details with comments. In a case where the property related information is not located in the database, the user can provide property related information based on an input via 613. The at least one processor directs the user to a web page where the user provides at least one property related information. In addition to that also the user can upload the files of an at least one data type discussed above.

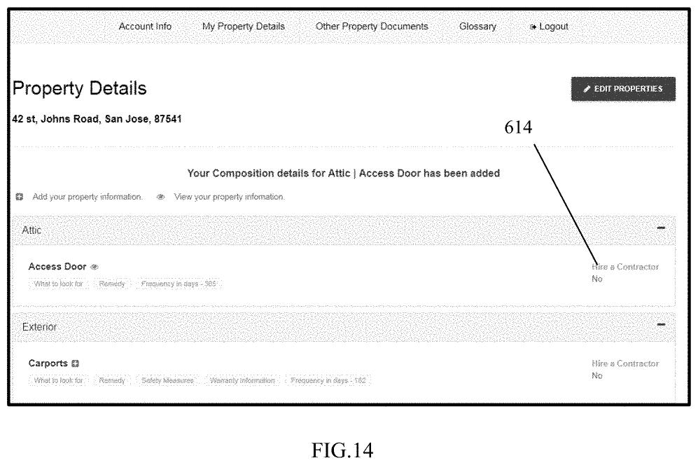

Referring to FIG. 14 represents adding property details and receiving confirmation from the server 300. In the edit property details, the user receives a pop-up notification based on the addition and update of the property details.

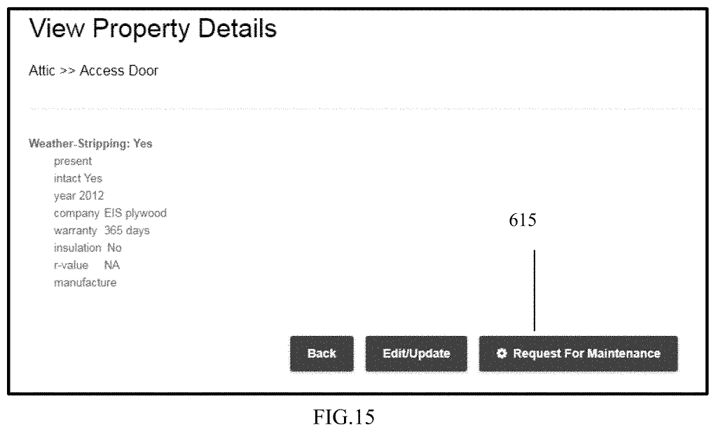

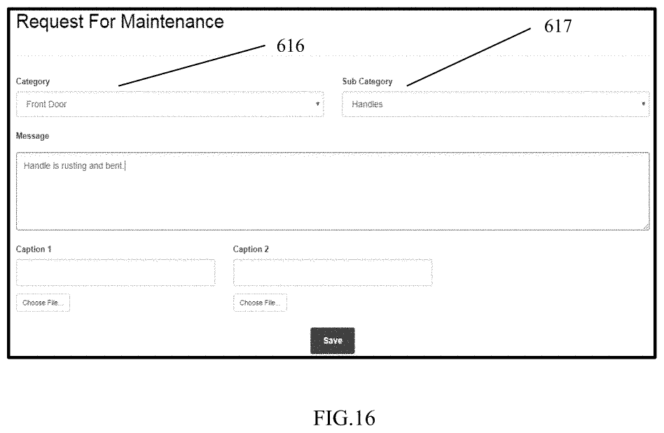

Referring to FIG. 15 represents the GUI (Graphical User interface) to display added property details and maintenance information. The user is provided with a back button, an edit/update button and a request for maintenance button 615. In addition to that, the user manually observes the property detail, for example, the access door and based on finding any discrepancy the user generates a request for maintenance based on the request for maintenance button 615. The detailed description related to the maintenance is described in FIG. 16.

Referring to FIG. 16 represents a plurality of categories 616, sub-categories 617, an editable area for providing a problem related to the property, captions for uploading image or data files related to the property and a save button to save the above-mentioned information.

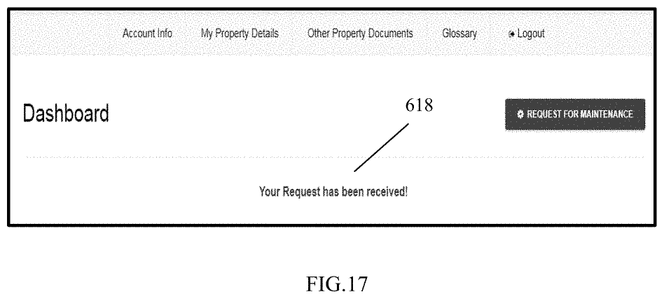

Referring to FIG. 17 is another representation of maintenance information in continuation of FIG. 15. The user receives an alert notification on either the GUI or a registered user device. The alert notification describes the reception of the request for maintenance has been received by the server 300.

The server 300 in response to the received request provides a list of eligible service providers based on a match with the requirements and the user profile. The user is directed to select at least one service provider based on the received list and the maintenance process done by the service provider is updated by the user in the database. The user can provide an update either in a report of the maintenance, image of the repaired area, or sensor data.

The request for maintenance generated based on whether a user request or a calendar notification. The calendar notifications are generated based on the at least one of uploaded property related documents, a manual request from the user, the sensor data, or image processing of the property-related items.

In one exemplary embodiment, the system updates the request for maintenance in the database where a plurality of registered service providers has access to extract or receive notification for any such request/notification. The plurality of registered service providers provides their charge code along with a type of services they will provide and a complete analysis chart in the form of the charge code and the services to be provided is transmitted to the user terminal. The user based on reception of the analysis chart makes his/her decision and a communication path is established between the service provider and the user.

The user can check and save the at least one item information related to the property provided in each and every page. After saving or submitting the property related information, the items will automatically default to start the maintenance schedule from the entry date. After submitting the at least one item information related to the property, the homeowner can give detailed information on each property by clicking on the property items. The homeowner can edit the property details or update the property details any time. The homeowner is able to see the list of properties selected and submitted by the homeowner based on a user input from the dashboard. Each house property includes a plurality of user defined options such as ‘what to look for’, ‘remedy’, ‘safety measures’, ‘warranty details’ and ‘frequency of days’ to be maintained. This makes the process simple and clear for the homeowner.

The what to look for button provides a detailed information about each item related to the property. The remedy button provides information characterizing the healthy or malfunctioning state of each item related to the property and the frequency of days is the number of days required to repair or maintain the specific item related to the property. A predefined number of days are set as the frequency of days in the system for each item related to the property. However, the user is capable of providing a different number of days for keeping the maintenance and services and receiving the notification for the same. The above information is stored in a maintenance database. The user receives notifications based on the information stored in the maintenance database.

The homeowner either can directly request a contractor or raise a request on the dashboard, anytime for any house property related service. The homeowner can update the property maintenance details in the dashboard so that the system can track and notify the homeowner on the next maintenance alert.

The homeowner is able to see the notification alert box and missed alerts on either of the dashboard page or on the display device of the communication terminal. The notification can be in the form of text messages, email, or audio/video calls based on the subscription availed by the homeowner. The notification alerts are the alerts related to the properties which need to be maintained on certain dates. The missed alerts are those alert notifications which the homeowner might have missed/ignored to maintain the property. The homeowner can update his membership to get the uninterrupted maintenance related service after the expiration of the allotted time.

In one exemplary embodiment of the invention a set of instructions executed by the computer to generate a notification related to maintenance. The notifications are generated based on the at least one item information related to the property provided by the user. The server 300 stores history information of all the systems and items installed in the house. The alarm or notification is generated based on the need to proceed with maintenance to the different systems. The system also suggests the maintenance methods or which certified professional to be hired for specific services. The system is also able to store property related documents, architect related documents, plans, used defined permit to increase the value of the house at a sale or alert notifications related to a fire or similar tragedy.

In one another exemplary embodiment of the invention, the information related to all the systems installed in the house is stored in the server 300 and is accessible from anywhere. The user is not necessarily to go to the particular location of the house to see the actual conditions and then search for different professionals to repair and maintenance. The user can remotely analyze the actual conditions of the house from anywhere and before any fatal damage to occur, the user will be able to take suitable actions based on the received notifications.

In one another exemplary embodiment of the inventive subject matter, a complete list of how to maintain and/or repair all parts of the individuals' home is provided on the server 300. An alarming reminder on a smart device triggers the process of maintenance. The homeowner is able to access a list of vetted professionals and select any one of those professionals if the homeowner wants that professional to do work. With the help of periodic maintenance, the value of the property will increase.

In one another exemplary embodiment of the inventive subject matter, the warranty date of at least one item is specified in the system to claim any damage incurred (fire, theft), or window damage easily. The value of the house is Increased based on registering information on the system. Homeowners can check the details of the home professionals before finalizing at least one professional to ensure safety as well as cost related constraints.

In one another exemplary embodiment of the inventive subject matter, this process is pertaining to all aspects of home maintenance, upgrades, home remodeling, and new home construction and all rooms and/or yards and home systems. An online searchable database of information regarding home systems and home maintenance management provides data related to management of home maintenance, home systems and products. The database provided for the purposes of tracking, maintenance, repair, cleaning, restoration, painting, renovation and building of homes including but not limited to roofing, decks, siding, awnings, doors, flooring, windows, cabinets, countertops, home alarm systems, smoke detectors, carbon monoxide detectors, home appliances, heating and cooling systems, water heaters, solar panels, elevators, home plumbing systems, home electrical systems, and home lighting systems.

In one another exemplary embodiment of the inventive subject matter, a website provided with online non-downloadable software for tracking, managing, organizing and storing data and providing alerts regarding home systems and home maintenance items for the purposes of maintenance, repair, cleaning, restoration, painting, renovation and new construction, including but not limited to, roofing, decks, siding, awnings, doors, flooring, windows, cabinets, countertops, home alarm systems, smoke detectors, carbon monoxide detectors, home appliances, heating and cooling systems, water heaters, solar panels, elevators, home plumbing systems, home electrical systems, home lighting systems. The data provided by the homeowner is stored in a storage space such as server 300 or cloud, but not limited to these only, for all supporting household documents including but not limited to plans, warranties, manufacturers' specifications, permits. The inventive subject matter provides access to professionals and/or training in the form of either documents or digital content such as audio or video, to track systems, perform maintenance and help homeowners/property managers/business owners with education and/or service.

In one another exemplary embodiment of the inventive subject matter, a first revenue stream for household professionals, a second revenue stream for home improvement store is added in the database. Information related to the importance of maintenance is also provided to the user in the form of digital media. This means of providing information educates the user and motivates the user to indulge in the maintenance services. In the specification, the terminology for the user and the homeowner are used interchangeably. This system provides various offers, discounts, or incentives for homeowners that avails the alert related services and maintains their property regularly.

In one another exemplary embodiment of the inventive subject matter, the home maintenance system is individualized to each home and generates automated reminders for each home. The system stores historical data of maintenance and other information in a storage device.

The disclosed invention is presented with reference to the accompanying drawings. The purpose served by the disclosure, however, is to provide an example of the various features and concept related to the invention and not to limit the scope of the invention.

Even though we mentioned the structure related to housing in the specification, this system could also be used for similar work of construction and application to all the construction sites and similar applications. It will finally be understood that the disclosed embodiments are presently preferred examples of how to make and use the claimed invention, and are intended to be explanatory rather than limiting the scope of the invention.

Reasonable variations and modifications of the illustrated examples in the foregoing written specification and drawings are possible without departing from the scope of the invention. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the inventive subject matter.

What is claimed is:

1. A system to provide maintenance services comprises:
a storage device to store a plurality of user credentials; and
a central processing unit (CPU) configured to:
receive a first user credentials, via a user interface, from at least one user;
compare the first user credentials with at least one second user credentials of the plurality of user credentials stored in the storage device to authenticate a first user;
receive, via the user interface, at least one item information related to a property from the first user and store the received at least one item information in the storage device;
generate at least one notification based on information stored in a maintenance database,
wherein an information stored in a maintenance database comprises the first user-defined start time/end time associated with the at least one item information and product warranty information, provided by the first user; and
transmit, via a transmission path, the generated at least one notification to a first user device,
wherein the generated notification is displayed on a display unit of the first user device.

2. The system according to claim 1, wherein at least one sensor and at least one timer coupled with at least one item related to the property, and
wherein the at least one sensor and the timer transmits sensor data and usage history of the at least one item related to the property to the storage device.

3. The system according to claim 1, wherein the central processing unit (CPU) is further configured to:
determine a usage-time of the at least one item related to the property based on the usage history received from a timer, and
determine at least one parameter based on reception of a sensor data.

4. The system according to claim 3, wherein the central processing unit (CPU) is further configured to generate the at least one notification based on the determined usage-time or the determined parameters.

5. The system according to claim 3, wherein the at least one parameter comprises temperature, humidity, current rating of the at least one item related to the property.

6. The system according to claim 1, wherein the central processing unit (CPU) is further configured to provide a list of service providers, for at least one service, to the first user device based on reception of a service request from the first user device.

7. The system according to claim 1, wherein the first user credentials selected from one of the following: at least one of registered username, face recognition, voice command, biometric information, a one-time password (OTP), and payment information.

8. The system according to claim 2, wherein the at least one service is provided to the first user based on the first user-initiated request.

9. A method for providing maintenance services, the method comprising:
receiving, via a user interface, a first user credentials from at least one user;
comparing the first user credentials with at least one-second user credentials of the plurality of user credentials stored in a storage device to authenticate the first user;
receiving, via the user interface, at least one item information related to a property from the first user; and storing the received at least one item information in the storage device;
generating at least one notification based on maintenance database,
wherein the maintenance database comprises the first user-defined start time/end time associated with the at least one item information and product warranty information, provided by the first user; and
transmitting, via a transmission path, the generated at least one notification to the first user device,
wherein the generated notification is displayed on a display unit of the first user device.

10. The method according to claim 9, further comprises transmitting sensor data associated with the at least one item related to the property and usage history of the at least one item related to the property in the storage device.

11. The method according to claim 10, further comprises determining a usage-time of the at least one item related to the property based on the usage history of the at least one item related to the property and determining at least one parameter based on reception of sensor data.

12. The method according to claim 9, further comprises generating the at least one notification based on the determined usage-time or the determined parameters.

13. The method according to claim 9, further comprises providing a list of service providers, for at least one service, to the first user based on reception of a service request from the first user.

14. The method according to claim 2, wherein the at least one service comprises home maintenance, home upgrade, home remodeling, or new home construction.

15. The method according to claim 9, further comprises tracking the at least one item information related to the property based on the maintenance database.

16. The method according to claim 9, wherein the at least one service selected form one of the following: maintenance, repair, cleaning, restoration, painting, and renovation.

17. A non-transitory computer-readable medium to store computer-executable instructions, executed by a processor, cause a computer to perform maintenance services, the method comprising:
receiving, via a user interface, a first user credentials from at least one user;
comparing the first user credentials with at least one second user credentials of the plurality of user credentials stored in a storage device to authenticate the first user;
receiving, via the user interface, at least one item information related to a property from the first user; and storing the received at least one item information in the storage device;
generating at least one notification based on maintenance database,
wherein the maintenance database comprises the first user-defined start time/end time associated with the at least one item information and product warranty information, provided by the first user; and
transmitting, via a transmission path, the generated at least one notification to the first user device,
wherein the generated notification is displayed on a display unit of the first user device.
